(19) United States
(12) Patent Application Publication
(10) Pub. No.: US 2026/0303729 A1
(43) Pub. Date: Oct. 1, 2026

(54) IN-FIELD DOCUMENT SCANNER CALIBRATION; DOCUMENT SCANNERS WITH INTEGRATED CONTACT BIOMETRIC SCANNING; AND DOCUMENT SCANNERS WITH INTEGRATED NON-CONTACT BIOMETRIC SCANNING

(71) Applicant: HID Global Corp., Austin, TX (US)

(72) Inventor: Daniel Henri Raguin, Jupiter, FL (US)

(21) Appl. No.: 19/577,485

(22) Filed: Mar. 25, 2026

Related U.S. Application Data
(60) Provisional application No. 63/777,143, filed on Mar. 25, 2025.

(51) Int. Cl. H04N 1/00; H04N 1/024; H04N 1/028; H04N 1/195; H04N 25/53

(52) U.S. Cl. CPC H04N 1/00087; H04N 1/00018; H04N 1/00034; H04N 1/00079; H04N 1/02409; H04N 1/02815; H04N 1/19594; H04N 25/53

(57) ABSTRACT

A document scanning device includes a platen including a contact surface on which documents to be scanned are placed; an imaging unit to capture image data of the documents; a calibration feature; a memory; and a controller operatively coupled to the memory and the imaging unit. The controller is configured to initiate capture of image data of a calibration feature included in the document scanning device by the imaging unit; measure imaging calibration metrics of the calibration feature using the image date; compare the measured imaging calibration metrics to stored calibration metrics stored in a memory of the document scanning device; and initiate a corrective action when one or more of the measured imaging calibration metrics differs from corresponding stored calibration metrics by more than a threshold metric difference.

### PRIORITY APPLICATION(S)

This application claims priority to U.S. Provisional Patent Application No. 63/777,143, filed on Mar. 25, 2025, the disclosure of which is incorporated by reference herein in its entirety.

### TECHNICAL FIELD

Embodiments illustrated and described herein generally relate to document scanners that authenticate documents.

### BACKGROUND

Travel documents are used to authenticate the identity of travelers at border crossings. These travel documents may be government-issued passports, driver's license, national ID cards, etc., that contain various machine-readable zones (MRZ) which typically code information about the traveler including their name and date of birth. The travel documents may also contain optical variable devices (OVDs) that can change color and/or appearance with different illumination angles, wavelengths or polarizations. Examples of OVDs include holograms, optically variable inks, and diffractive structures. Although travel documents may be checked by a human, the preferred method of checking these documents from the standpoint of speed and accuracy is to use a document scanner specifically designed to automatically determine authenticity of travel documents through scanning. A document scanner needs to be optically calibrated properly during factory assembly in order to consistently capture imagery used by its document authentication algorithms, but there is no guarantee that the document scanner will maintain this calibration once it leaves the factory.

### BRIEF DESCRIPTION OF THE DRAWINGS

FIG. 1 is a side view of an example of portions of a document scanning device that performs in-field calibration checks.

FIG. 2 is a schematic diagram showing detail of an imaging unit of a document scanning device.

FIG. 3 is an illustration of a representative image taken by an imaging unit of a document scanning device.

FIG. 4 is an expanded view of the border of a document scanning device showing a peripheral field of view area where calibration features usable for self-calibration by the document scanning device may be positioned.

FIGS. 5A-5C show examples of positioning of the calibration features usable for self-calibration by the document scanning device.

FIG. 6 is a flow diagram of an example of operating a document scanning device to perform an in-field calibration procedure.

FIG. 7 illustrates an example of an alternative placement and type of calibration features useable for device self-calibration.

FIG. 8 illustrates an example of an alternative type of calibration feature and an alternative placement of the calibration feature.

FIG. 9 is an illustration of a subset of the components of a document scanning device and how it can be used to scan a biometric presentation.

FIG. 10 is a view of the platen area of the example document scanning device of FIG. 9.

FIG. 11 illustrates a portion of human skin as a contact biometric presentation and a portion of an example of a document scanning device.

FIG. 12 illustrates an image of a hand captured by the imaging unit of the document scanning device for a contact biometric presentation of the hand.

FIG. 13 is a flow diagram of an example of a method of operating a document scanning device to authenticate documents and authenticate the bearer of the documents.

FIG. 14 is an illustration of a subset of the components of a document scanning device and how the device can be used to scan a non-contact biometric presentation.

FIG. 15 is an exaggerated view of the platen area of the document scanning device of FIG. 14.

FIG. 16 is an illustration showing another example of a non-contact biometric presentation including a palm of a hand.

FIG. 17 is an illustration showing another example of a non-contact biometric presentation of a finger and a portion of a document scanning device.

FIG. 18 illustrates another example of a portion of human skin and a portion of a document scanning device.

FIG. 19 illustrates another example of a portion of a document scanning device that includes an additional mirror enabling a non-contact biometric presentation of a face or iris of a human subject to be imaged.

FIG. 20 is an example image captured by a document scanning device from a non-contact biometric presentation.

FIG. 21 illustrates an example image of the face of a human subject captured by a non-contact biometric presentation to the document scanning device.

### DETAILED DESCRIPTION

As explained previously herein, travel documents can include machine-readable zones (MRZ) and optical variable devices (OVDs) that a document scanner can analyze to determine authenticity of the documents. To read the MRZ and the OVDs, to capture the face picture of the traveler off of the travel document, as well as to check the color of the inks and paper used, the travel document is placed face down onto a platen (typically glass for scratch-resistance) of the document scanner. Within the document scanner, an optical imaging system and an internal illumination system are housed. Illumination of the platen is generally achieved with the use of light emitting diodes (LEDs) as this technology is low-cost and power efficient. In order to check the authenticity of the OVDs, ink, and paper present on the travel document, LEDs of different wavelengths may be used to illuminate the document paper. Red, green, blue or white-light LEDs may be used to obtain visible wavelength images of the document. Ultra-violet (UV) LEDs (e.g., 365 nanometer (nm) wavelength) may be used to incite a fluorescence of the travel documents paper to serve as an authentication check. To check fluorescence, the imaging system may contain a spectral filter that blocks out the UV light used so that only the fluorescing component may be detected. LEDs in the near infrared (NIR) may also be used in the illumination system. Imaging using NIR may reveal the authenticity of the ink used in the document. For example, authentic ink used in travel documents will appear black in both visible light and in the NIR, while low-quality ink will appear black in visible light but will appear gray in the NIR indicating that the scanned travel document is not authentic.

During factory assembly, the document scanner must be focused properly and have the correct white balance adjustments in order to capture the correct color imagery used by the document authentication algorithms of the device. Resolution as well as white and gray targets may be temporarily placed on the platen during factory calibration to ensure best focus and color balance, but the document scanner may need re-calibration after it leaves the factory and is in use. One approach to recalibrate the scanner is to have the operator manually place a white card or potentially a resolution target onto the platen to check the focus quality and color balance while the document scanner is deployed in the field. This is not a preferred method since it requires an operation by the operator that is outside of the usual activities and training of the operator. A preferred approach would be for the device to automatically perform an in-field focus and color calibration procedure without the need for operator assistance.

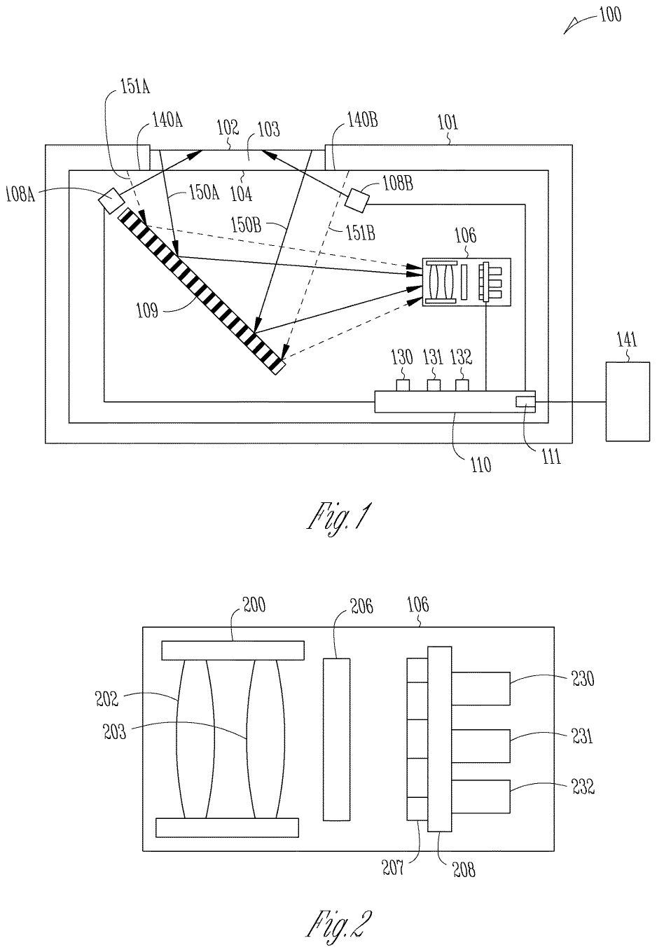

FIG. 1 illustrates an example of portions of a document scanning device 100 that performs in-field calibration checks without the need of outside assistance by an operator or other human. The document scanning device collects image data from documents placed in a document field of view (FOV) of the imaging system of the document scanning device and performs algorithms on the image to determine authentication of the documents. The in-field calibration checks may include the device-based calculation of imaging calibration metrics that relate to the focus quality, imaging magnification and distortion, and color balance of the document scanner. The document scanner calculates the imaging calibration metrics using image data of calibration features positioned with the overall full-field of view of the imaging system. The calibration metrics are used to determine the performance level of the document scanning device and may calibrate the imaging system to meet certain metric threshold if possible, or to determine that the reader no longer meets the required performance metric and should be repaired or replaced.

FIG. 1 is a schematic diagram of the cross-section of a document scanning device 100. The document scanning device 100 comprises a housing 101 with a platen 103. The platen 103 has a contact surface 102 upon which is placed a document to scan and a bottom surface 104 opposite the contact surface 102. Platen 103 is preferably transparent to visible and near infrared (NIR) wavelengths and is scratch-resistant as this surface comes in repeated contact with documents. Consequently, glass is a preferred material for platen 103 though other materials such as plastics, particularly those with hard coatings, may be used. Housing 101 contains one or more illumination units (108A and 108B) and imaging unit 106 that may include a camera. Imaging unit 106 is connected to a controller that includes control printed circuit board (PCB) 110. For packaging purposes, the document scanning device 100 contains at least one fold mirror 109.

The illumination units 108A, 108B contain one or more light sources and the required optics to generate the light distribution required at platen contact surface 102. Light sources are preferably those that are capable of emitting light of visible and NIR wavelengths and are energy efficient, such as light emitting diodes (LEDs) for example. Visible wavelengths are preferred to capture an image of the document as a human would see it and the device can perform optical character recognition (OCR) on any MRZs present in the document. NIR wavelengths are preferred for authentication of inks used in the document as many low-cost forgery inks will look black in the visible but have very low contrast in the NIR. Another wavelength spectrum that may be incorporated into the illumination units 108A, 108B of a document scanning device 100 is ultraviolet (UV). At these wavelengths, for example, 365 nm, the paper of the document may fluoresce, and detection of the fluorescence may be used as an authentication metric. Although two illumination units 108A, 108B are illustrated, the document scanning device 100 may include one illumination unit or more than two illumination units and the orientation of the illumination units 108A, 108B may differ from that in FIG. 1. By way of example, an illumination unit may be positioned in-line with the imaging unit 106 or several illumination units may be placed in a ring underneath the border of platen 103. Preferably, the arrangement and number of illumination units, coupled with the design of the illumination optics in conjunction with the light sources, creates a reasonably uniform illumination of the area of the contact surface 102 where the document is intended to be positioned.

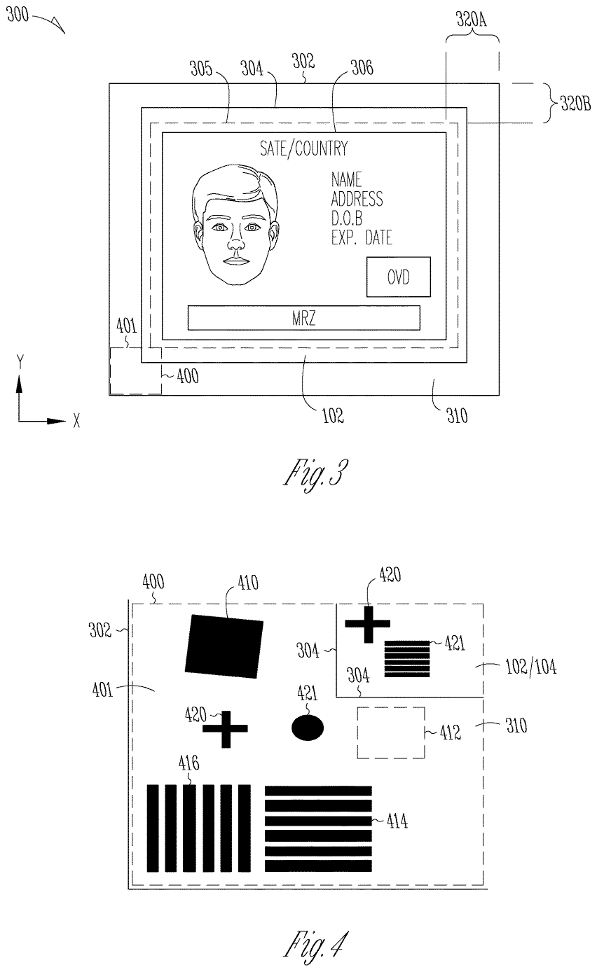

FIG. 2 is a schematic diagram showing detail of an imaging unit 106. Imaging Unit 106 may contain one or more imaging optics 202, 203, spectral filter 206, image sensor 207, camera PCB 208, processors 230 and memory 231, 232. Imaging optics 202, 203 comprise the necessary optics (refractive, reflective, diffractive or Fresnel) to image the contact platen surface 102 onto image sensor 207. Spectral filter 206 blocks unwanted light of certain wavelengths from reaching image sensor 207 in order to maximize the contrast of the desired image. By way of example, if it is desired to image the document using light in the visible spectrum, check the ink of the document using light in the NIR spectrum, and observe the visible fluorescence of the document paper under UV exposure, then spectral filter 1-206 is preferably designed to pass visible and NIR wavelengths and to block UV wavelengths.

Image sensor 207 is preferably a two-dimensional (2D) pixelated sensor and may be fabricated using charge-coupled detector (CCD) or complementary metal oxide semiconductor (CMOS) technology. It is preferred that image sensor 207 is capable of capturing color visible images, so a red-green-blue (RGB) sensor is preferred which contains mosaiced red, green, and blue sensitive pixels. Alternately an RGB-IR sensor may be used as this type of sensor has not only a mosaic of red, green and blue pixels, but also NIR sensors interspersed in the mosaic pattern. One or more processors 230 and volatile memory 231 (e.g., dynamic random-access memory, DRAM) and non-volatile memory 232 (e.g., electrically erasable programmable read-only memory, EEPROM) are optional as no processing or storage of the raw image from image sensor 207 may be required before the image data is sent to the controller and all imaging and camera control register settings may be stored in control PCB 110.

Imaging unit 106 may contain the necessary technology to vary the focus of its optics. By way of example one or more of imaging optics 202 and 203 may have a means by which their optical properties may be electronically addressed. Example means include the use of a liquid lens such as marketed by Optotune Switzerland AG or Corning with its Varioptic™ lens as well as deformable polymer lens such as marketed by PoLight (Norway) with its TLens™. A further example is the use of a voice coil motor (VCM) 200 in which the housing of one or more of the imaging optics 202 and 203 is attached to a voice coil and associated mechanics that allow for movement of the imaging optics longitudinally along the optic axis in a manner such that the object plane that is imaged onto image sensor 207 may be adjusted. The imaging unit 106 may vary the focus of its optics in response to commands from the controller.

Controller includes control PCB 110 and controls illumination units 108A,108B and imaging unit 106. Controller collects image data from imaging unit 106 and optionally processes the image data with processing circuitry that includes one or more processors 130 and memory 131, 132 and communicates with a host computer 141 using communication port 111. The PCB memory may comprise both volatile memory 131 and non-volatile memory 132. Within volatile memory 131 ca be stored the image data from imaging unit 106 as well as any programming instructions in software or firmware to be executed by the processing circuitry. Image data may be processed by processors 130 and 230 to select a lower bit depth than that of the raw data (e.g., selecting a proper 8-bit pixel depth from 10-bit or 12-bit raw data received). Processing may also entail correcting for geometrical distortions of the optical system and down sampling to a lower electronic resolution. Processors 130 and 230 may also perform background correction, contrast enhancement, frame averaging, or any other form of image processing designed to improve the fidelity of the captured images.

Imaging unit 106 is designed to capture at least the required document FOV. The document FOV may be a subset of the overall full-field of view of the imaging unit 106 and may be determined by the largest anticipated document to be scanned with a certain amount of margin added to it for possible misalignment of the document presented for scanning. An example of extreme light rays representing this document FOV are illustrated in FIG. 1 as rays 150A and 150B. However, the overall full-field of view of imaging unit 106 may extend beyond this document FOV. The imaging unit full-field of view may capture a larger area of contact surface 102 as well as potentially some of the mechanics that are supporting platen 103, such as for example the underside of housing 101, and housing parts 140A and 140B. The extreme rays representing this imaging FOV are represented in FIG. 1 by dashed rays 151A and 151B.

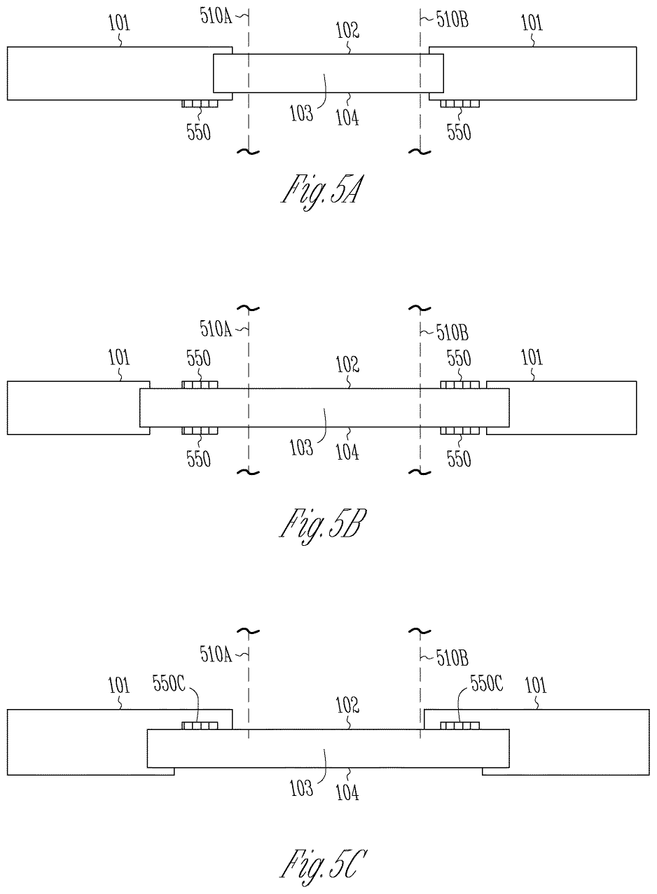

FIG. 3 is an illustration of a representative image 300 taken by the imaging unit 106. The full-field of view boundary of imaging unit 106 is labeled 302 while the document FOV boundary 305 is represented by the dashed rectangular bounding box. The area in between the full FOV boundary 302 and the document FOV boundary 305 is referred to as the peripheral FOV area 320, which along x and y directions may have widths of 320A and 320B, respectively. Within peripheral FOV area 1-320 of image 300 may be the image of contact surface 102, the mechanics 310 holding platen 103 or some combination thereof. As illustrated in FIG. 3, the boundary between contact surface 102 (or the opposite bottom surface 104) and support mechanics 310 is boundary 304. Within document FOV boundary 305 may be placed the image of a travel document 306 which typically contains a front-view face picture of the traveler with the traveler's name, address, date of birth and the expiration date of the document. The document may also contain an MRZ and one or more OVDs for added security. Outside of the document FOV boundary 305 and in the peripheral FOV area 320, there may be an area 401 bound by a virtual border 400 that may be used to contain calibration features of embodiments of the present invention designed for in-field calibration.

FIG. 4 is an expanded view of the area 401 within the dashed border 400 presented in FIG. 3 showing area 401 in a portion of peripheral FOV area 320 where the calibration features may be placed. These calibration features may include features designed to determine the optical resolution of the system through such metrics as modulation transfer function (MTF) or contrast transfer function (CTF). The calibration features may include a slanted rectangle 410 or bar targets 414 and 416 of different orientation and spatial frequencies. Calibration features may also include features designed to determine the electronic resolution and distortion of the optical system. Such features may include a crosshair 420 or a circle 421. By detecting the intersection of the two lines of the crosshair 420 or by determining the center of gravity of the circle 421, an accurate coordinate location for that feature can be calculated. By determining the locations of a collection of such calibration features, then a mapping of the electronic resolution of the optical system can be created, from which the magnification and the native distortion of the system may be calculated. It should be noted that area 1401 may contain areas of the support mechanics 310 as well as areas of the top contact surface 102 or opposite bottom surface 104 of platen 103. Consequently, calibration features (e.g., crosshair 420 and bar target 414) may also be placed on contact surface 102 and bottom surface 104 to be used for in-field calibration.

These examples of calibration features allow the document scanning device 100 to be calibrated at the factory for magnification, distortion, electronic resolution, and optical resolution and may be analyzed in conjunction with data obtained from imaging other targets or features that are temporarily placed on contact surface 102. The results of the factory calibration may be stored in non-volatile memory 132, 232. While in the field, at set time intervals (e.g., at start-up or other suitable times) the document scanning device software or firmware may conduct in-field calibration checks using these calibration features and compare the in-field results to those stored in the device memory. If the in-field results differ by more than a certain threshold value, the document scanning device may issue a warning indicating that it is out of calibration, or it may try to adjust its optical system to correct the issue and rerun the calibration check steps. By way of example, the system may contain an autofocus mechanism (e.g., a voice coil motor or VCM 200 in FIG. 2) that allows focus to be adjusted and to correct an image resolution issue.

Another calibration feature for the document scanning device is one that allows for color or white-balance calibration. In FIG. 4, dashed area 412 may represent an area of the FOV that contains a color patch that has a specific pigmentation. The specific pigmentation may be white or off-white pigmentation, but it could be a gray pigmentation, or any other pigmentation color. During factory calibration, images may be taken with different illumination wavelengths and the response of the various color pixels of image sensor 207 recorded in the non-volatile memory of document scanning device 100. In this manner the proper ratio of red, green and blue raw pixel grayscale values may be calculated to arrive at image data that displays the correct color balance, given the illumination color balance of the light emitted by illumination units 108A and 108B, the spectral response of pixels of image sensor 207, as well as the spectral response of the imaging optics 202, 203 and spectral filter 206. The color correction of the raw image data may be calculated and implemented as a constant algorithm across the image sensor 207 or may vary spatially across the image sensor 207. Further this color calibration procedure can calibrate the exposure or illumination level of the imaging unit 106. The factory color and exposure calibration may change in the field due to the illumination units losing power as they age with use. By checking and calibrating using the in-field calibration features of embodiments of the present invention, the document scanning device 100 may adjust one of more of the current of various light sources within illumination units, the integration time of the pixels of the image sensor, the analog and digital gain of the pixel signal at the image sensor level, and the digital gain applied in software when displaying or analyzing a raw image.

Fabrication of the calibration features depicted in FIG. 4 may be performed using technologies such as silk screening and photolithography. As an illustrative example intended to be non-limiting, the calibration features may be fabricated on contact surface 102 and bottom surface 104 using a photolithographic patterning and etching procedure to create these features in metal, such as chromium (Cr). Depending upon the resolution required, the calibration features may be printed onto a sticker that is then affixed to the appropriate location and component of the document scanning device 100. The locations of the calibration features may vary depending upon the requirements of the system.

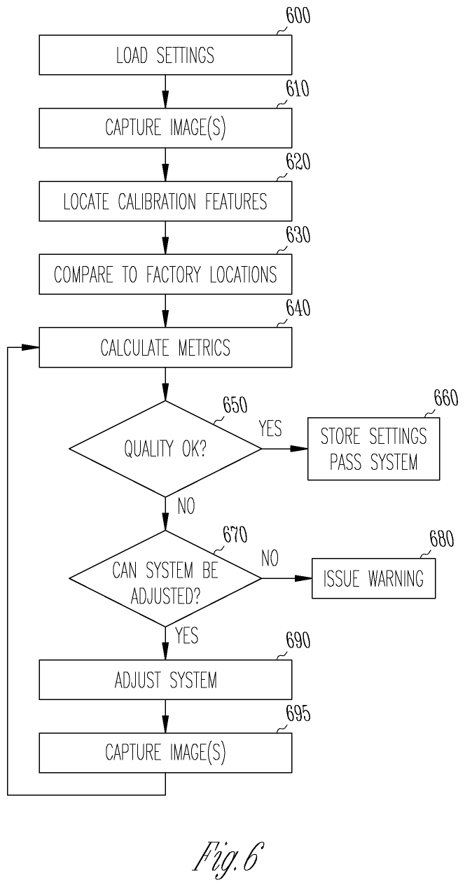

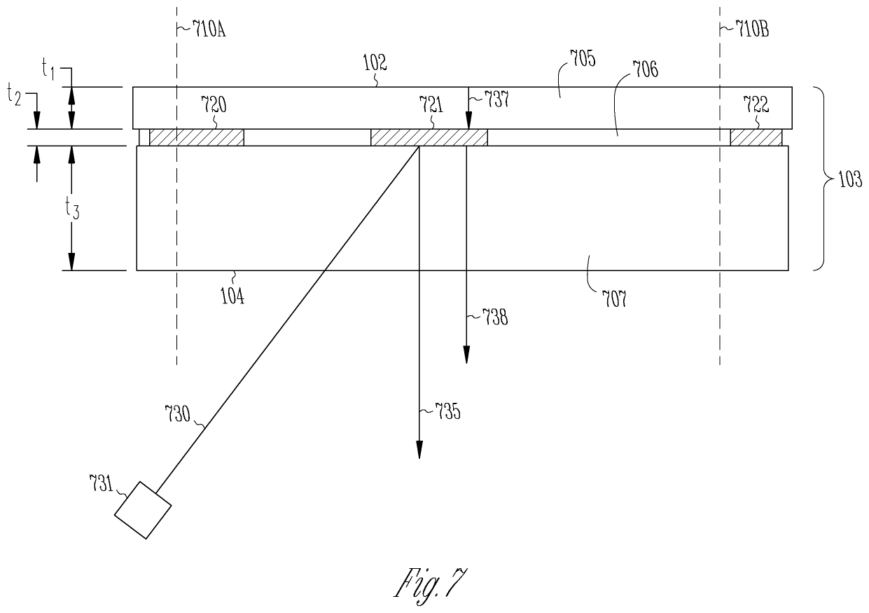

FIGS. 5A-5C show examples positioning of the calibration features. In FIG. 5A, calibration features 550 may be fabricated on a frame separate from the platen 103, for example the underside of housing 101, though this underside example is not a requirement. In FIG. 5B, calibration features 550 may be placed on the platen 103 itself either on the contact surface 102 or the opposite bottom surface 104, or both, if platen 103 extends sufficiently outside the required document FOV capture area of the document scanning device 100. The extent of the document FOV capture area is denoted in FIGS. 5A-5C, by way of example, by the two dashed lines 510A and 510B. Between these two lines is the area the document scanner is expected to capture an image of a travel document. Outside of dashed lines 510A and 510B are areas where the calibration features may be placed that otherwise may disrupt the proper imaging of a document. If calibration features 550 are placed on platen 103 rather than onto metal or plastic or other material of the housing 101 or another mechanical feature surrounding platen 103, then the calibration features 550 may be printed onto the material of platen 103 which may be, by way of example and not limitation, glass or plastic. If calibration features 550 are positioned on bottom surface 104 of platen 103, the imaging system can be calibrated accounting for the distance that contact surface 102 is offset from surface 104.

In FIG. 5C, calibration features 550C are placed on contact surface 102, but outside the document FOV. Further, housing 101, or another mechanical component of the document scanning device 100 is placed over calibration features 550C on one portion of the platen and while exposing the contact surface 102. In this way, the calibration features cannot be mechanically touched and are therefore protected from mechanical wear or from liquids (e.g., solvents like isopropyl alcohol or methanol) that might be present during a platen cleaning procedure that is conducted periodically. For the case of the calibration feature being ones designed to perform color and exposure calibration, these features may be separate printed features. Alternatively, the mechanical component placed outside the document FOV but within the imaging FOV may be designed such that the color of this material is sufficient for the color and exposure calibration required.

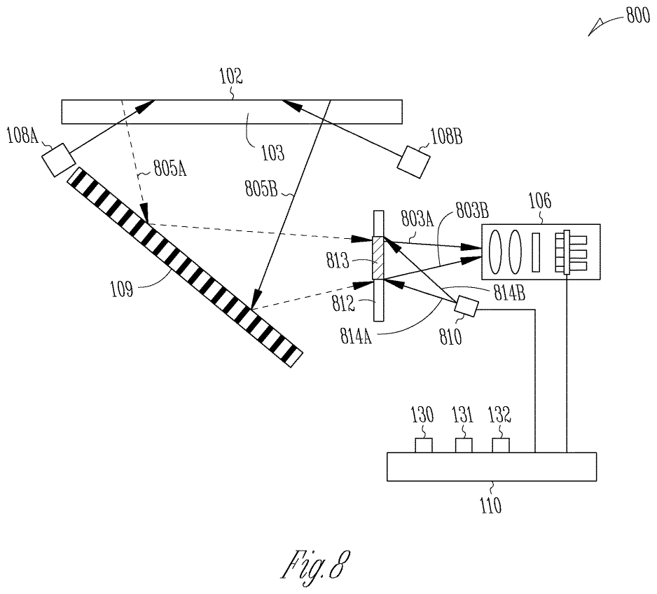

FIG. 6 is a flow diagram of an example of operating a document scanning device to perform an in-field calibration procedure. The method can be performed using the document scanning device 100 in the example of FIG. 1. In operation 600, the document scanning device loads the settings for capturing an image, for example from non-volatile memory 132. In operation 610, the controller initiates capture of image data of one or more images by the imaging unit 106 and in operation 1-620 locates the calibration features in the images. By way of example, this may be by finding the center of mass of rectangular or circular features or locating intersection of crosshairs in the calibration feature image region. The location of these detected features may be used to determine regions where other features are, for example bar targets. In operation 630, the locations of the calibration features may be compared to their factory-determined locations, and in operation 640 various imaging calibration metrics of the calibration features are calculated using the processing circuitry of the controller. The imaging calibration metrics may include features such as MTF of slanted edge calibration features and CTF of bar target calibration features. Imaging calibration metrics such as magnification and distortion may be determined by looking at the calculated locations and separation distances of calibration features like a crosshair, rectangles, or circles and comparing pixel separations distances to those distances stored in non-volatile memory. The imaging calibration metrics may also include color calibration. The color calibration may be derived from the grayscale values of different color pixels (e.g., red, green, blue and/or infrared) for certain illuminations in the region of a color calibration feature are calculated and compared. Note that the data collected to perform color calibration may be captured with a single image if the sensor is color and only RGB color calibration may be required. Alternatively, more than one image may be required if the sensor is monochrome and the capture of a color image is performed by separately illuminating the platen with sequences of red, green, blue light and capturing different images for each illumination. Still alternatively, if color calibration at NIR wavelengths is required as well, even with a color image sensor, at least two images may be required wherein one image is captured with visible light illumination and a second image is captured with NIR illumination.

In operation 650, the calculated calibration metrics calculated by the processing circuitry are compared to required thresholds stored in memory of the document scanning device for these calibration metrics. The thresholds may be factory determined calibration metrics stored in the memory or tolerances of the calibration metrics determined during factory calibration. If the calculated calibration metrics pass, then the system may move to operation 660 and the controller may log, for example in on-board non-volatile memory 132, a successful in-field calibration check and may also store any determined parameters that relate to a new setting that the imaging system should be in to maintain calibration, as well as any new parameters needed for image processing of raw images to obtain properly calibrated images. If the calculated calibration metrics show the imaging system is not meeting the desired level of performance, the controller initiates a corrective action.

In operation 670 the controller determines if there are any adjustments that can be made to the imaging system to potentially improve the calibration metrics calculated. If the controller cannot make any changes or if the controller has already looped through all imaging system changes possible without meeting the desired level of performance, then the system may advance to step 680 and issue a warning to the operator as well as store in non-volatile memory a record of the failed in-field calibration operation. If on the other hand, the system can be adjusted, then the controller makes these adjustments in operation 690. These adjustments can include focusing of the imaging unit 106, for example if it contains a VCM, a liquid lens, or some other electronic means for changing focus. Adjustments can include changing the current of one or more illumination units and/or camera pixel integration time to tune the exposure level or color balance of the captured image. Note further that for the purposes of color balance, the imaging system may purposely defocus the imaging optics so that any defects (scratches, dust, etc.) on a color calibration feature have minimal effect on the color calibration. Alternatively, this defocus may be performed in software through a simple binning of pixels.

In operation 695, one or more new images may be captured using the new adjusted system settings from operation 690. From the new images, calibration features will be located, and calibration metrics will be calculated in operation 640 and the loop repeated until the imaging system is able to reach a pass or fail status of the in-field calibration routine represented in the flow diagram of FIG. 6.

A downside of locating the calibration features in the positions illustrated in FIGS. 3-5 is that calibration features are outside of the document FOV. Because these calibration features are in the peripheral area (outside of the document FOV, but inside of the imaging FOV), they do not obstruct the reading of the document, but given that they are outside of the document FOV, the imaging calibration metrics calculated for calibration features in these locations outside the document FOV can only be used to infer the imaging performance within the document FOV.

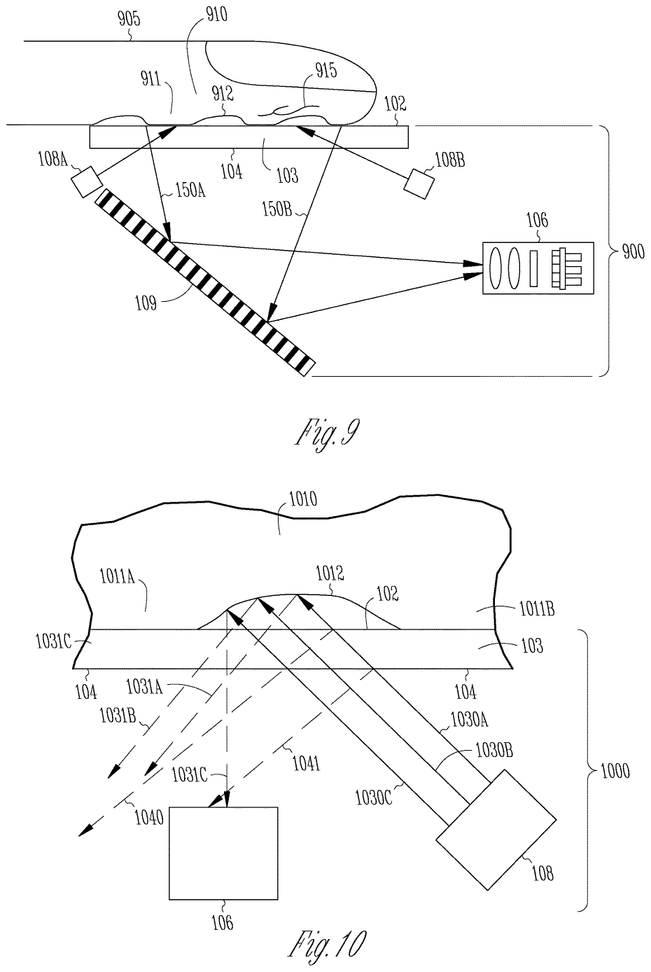

FIG. 7 illustrates an example of an alternative placement and type of calibration features. In FIG. 7, a cross section of platen 103 is illustrated in which the document FOV is bounded by dashed lines 710a and 710b. Platen 103 is comprised of layers 705, 706, and 707 that have thicknesses t₁, t₂, and t₃, respectively. The top layer 705 includes the platen contact surface 102 and the bottom layer 707 includes the platen bottom surface 104. Layer 706 is sandwiched between the top layer 705 and the bottom layer 707, and layer 706 may contain one of more calibration features 720, 721, and 722. Calibration feature 722 is positioned in the peripheral area outside of the document FOV (as represented by dashed lines 710A and 710B), but calibration feature 720 is partly in and partly out of the document FOV, while calibration feature 721 is completely within the document FOV. For calibration features that are within the document FOV, they must have minimal effect on the imaging of a document. Consequently, they desirably are not a printed sticker, a painted spot for color calibration, or a patterned Cr on glass area or similar feature that has light absorptive properties. An alternative is to use diffractive or holographic structures as the calibration features within the document FOV. The diffractive or holographic structures can be used in augmented reality (AR) and virtual reality (VR) headsets, goggles, and glasses. AR/VR devices project light from the temples of the device towards the lenses or visor of the device that the users look through. A grating or hologram is integrated into the lenses or visor which then reflects this light towards the user's eye and in this manner virtual or augmented scenery or data may be viewed by the user. The gratings in AR/VR devices are Bragg gratings or holograms and therefore allow the reflection to occur with high efficiency, yet simultaneously minimally interfere with the transmission of ambient light coming from whatever scene at which the user is looking.

In a similar manner, light from illumination unit 731 emits light 730 that is directed at calibration feature 721 that can be a diffractive feature such as a Bragg grating or hologram. Due to the Bragg effect of a diffractive calibration feature, a significant percentage (e.g., >50%) is diffracted as reflected light 735 and this light is within the full FOV of imaging unit 106 and so is imaged. Light 730 may be a reasonably uniform beam of light, but reflected light 735, due to the grating or holographic properties of calibration feature 721, may contain light that is spatially structured in a pattern similar or different from any one of the features presented in FIG. 4, such as a bar target 414 and 416, a slanted rectangle 410, crosshair 420, or a circle 421. The diffractive calibration feature 721 may also serve as a color calibration mark as well. In this case, the reflected light 735 may be reasonably uniform as well.

When calibration illumination unit 731 is not turned on, but other normal illumination units (not shown) are turned on and a document is placed on contact surface 102, light 737 travelling from the contact surface 102 will interact with calibration feature 721. Light 737 may originate as a reflection or scatter off of a document being scanned. Due to the Bragg effects of calibration feature 721, a significant majority (e.g., >90%) of light 737 will transmit through calibration feature 721 undeterred as light 738 and be imaged by imaging unit 106. As part of a factory calibration, a blank white or gray card may be placed on contact surface 102 with the normal illumination units turned on for document scanning and one or more images may be captured by imaging unit 106. Any spatial distribution of light seen in the images due to the calibration features being present within the document FOV may be treated as fixed pattern noise and corrected using standard flat-field or background correction image processing techniques.

The calibration features 720, 721, and 722 in FIG. 7 may be diffractive in nature and may be fabricated holographically (for example in dichromated gelatin (DCG) or a photopolymer) or fabricated digitally with a photolithographic or direct laser writing process into a photoresist or similar material. The photoresist pattern may be transferred via etching into a more durable material. Master versions of the diffractive calibration features may be fabricated and replicated using techniques such as nanoimprint lithography. The thickness of the diffractive calibration feature to be written or imprinted is fairly thin, on the order of microns. Therefore, the thickness t₂ of layer 706 is generally on the order of microns. The top layer 705 and top layer 707 are made from suitably transmissive material such as glass and plastic and have thicknesses that maintain the required rigidity for documents to be placed upon the platen 103. If the calibration feature 721 is more of a grating, then the diffracted image of a resolution feature will appear as if it came from layer 706. Therefore, depending upon the depth of field of the imaging unit 106, there may be a preference to have the thickness t₁ of the top layer 705 to be as thin as possible such that the image of the calibration feature is located as close to the contact surface 102 as possible. By way of example, ultrathin glass can be used that is 100 micrometers (100 μm) or less in thickness and even 35 μm or less in thickness. Using such thin glass for top layer 705 allows calibration feature 721 to be very close to contact surface 102. Bottom layer 707 may then be a thickness that is sufficient for mechanical robustness, for example 1 to 3 millimeters (mm) thick.

In some examples, calibration feature 721 can be holographic in nature. In other words, light 738 diffracted from the calibration feature 721 may represent the wavefront of an object that is not located at the same plane that middle layer 706 is in. Instead, the calibration feature 721 may be designed such that the virtual object, to be imaged by imaging unit 106, is in fact at or very near contact surface 102. In this case, calibration feature 721 need not be physically close to contact surface 102 and therefore top layer 705 need not be fabricated out of ultrathin material. If calibration feature 721 need not be sandwiched between layers 705 and 707 because of handling during assembly or environmental issues (e.g., adverse reaction with oxygen over time), then bottom layer 707 may be considered optional. Layer 705 may then by itself be of a chosen thickness t₁ that on its own provides the mechanical rigidity required of the platen 103 of the document scanning device.

FIG. 8 illustrates an example of an alternative placement and type of calibration feature. FIG. 8 is a simplified cross section of a document scanning device 800 compared to the cross-section in FIG. 1 for clarity of the placement and operation of a holographic calibration feature. The document scanning device 800 includes a plate 812 containing a holographic calibration feature 813. The plate 812 is placed within the full FOV of imaging unit 106. An illumination unit 810 is configured to illuminate calibration feature 813 with a beam of light having light preferably at least between rays 814A and 814B. Holographic calibration feature 813 diffracts this beam of light into a reflected beam bound by rays 803A and 803B and this reflected beam is imaged by imaging unit 106. The holographic calibration feature 813 is preferably designed such that the diffracted reflected beam represents a virtual object located at or near contact surface 102, as indicated by dashed rays 805A and 805B. The virtual object may contain a plurality of features such as those represented in FIG. 4 upon which the imaging system may perform in-field calibration as previously described. In this manner, holographic calibration features such as 813 may be located anywhere between contact surface 102 and imaging unit 106 and within the FOV imaging unit 106 and still create a virtual object located at or near contact surface 102 that contains the required calibration features upon which a system may perform in-field calibration. Holographic calibration features may be placed on a separate plate or on another component of the optical system, which by way of example may be fold mirror 109. The holographic feature 813 is designed such that it either is not Bragg matched to other illumination contained within the document scanner or is not illuminated by the document illumination units 108A and 108B. Further, the holographic feature 813 is designed to have minimal effect on the standard imaging of documents placed upon contact surface 102. As illustrated in FIG. 8, the placement holographic feature 813 prevents illumination by document illumination units 108A and 108B.

The techniques of in-field calibration described allow a document scanning device to perform in-field calibration with no action by an operator and in this manner regularly ensure that the scanner is operating at the same or similar level to when it left the factory. Documents such as travel documents can continue to be checked at the location of deployment with reduced need for servicing by a trained technician.

However, even if the document scanning determines that the document is genuine it may be needed to confirm that the bearer of the document is indeed the same person identified in the document. Biometrics can be used to verify identity of the person bearing the document. Generally, a separate authentication process is required with an apparatus separate from the document scanning device in order to check the fingerprints or face biometrics of the person carrying the documents.

Integrating a contact biometric presentation scanner into the document scanning device allows both the person and their documents to be authenticated in one process. Additionally, biometric scanning with the document scanning device provides for authentication of the identity of the operator running the document scanner as part of a login process for the operator. The document scanning device 100 in FIG. 1 may also be capable of performing biometric scans for the purpose of identification or verification of the bearer of the document.

In addition to reading identifying information from the document to determine whether or not the document is genuine or a forgery, the document scanning device 100 performs a contact biometric scan of a biometric presentation, such as friction ridge topology, vein, or hand geometry, for purposes of matching the identity specified on the document to the identity of the bearer of the document. Biometric matching of the document bearer may be performed by matching the captured biometric presentation with previously stored biometric data for that individual to which the system has access. In certain examples, the biometric matching may be performed based upon biometric data stored within the document itself (e.g., stored in a chip of an e-Passport). The biometric matching of an individual does not need to be restricted to an individual passing a checkpoint where the document scanning device 100 is part of the secure access system. The identification of an individual based upon their biometric presentation may be used to confirm that the operator of a document scanner is a person authorized to operate the scanner. This operator identification may be performed as part of a login process as well as a periodic confirmation of the operator identification or an operator identification requirement depending upon a certain traveler scenario. For example, operator identification may be required if an operator declares a travel document to be authentic despite the document scanning device giving it a high forgery score.

Returning to FIG. 1, as explained previously herein, example extreme rays representing the document FOV are illustrated as rays 150a and 150b. However, the full FOV of imaging unit 106 may extend beyond this document FOV. The extra margin of the imaging FOV over the document FOV may be designed such that the contact biometric presentation need not occur in the same portion of the platen as where the document is placed. This may be preferential for allowing both a document and a biometric presentation to be presented simultaneously and so that the area where the document is to be placed does not get contaminated from oils, dirt, debris, etc. from the contact biometric presentation. Another means of scanning a contact biometric presentation outside of the document FOV is to have a means by which the optic axis can be shifted towards the expected area where the contact biometric presentation is to be made. By way of example, mirror 109 or another mirror in the system may rotate. In this case it is preferential that the tilting mirror in the system is close to imaging unit 106 such that its area is smaller, which means the mirror 109 is lighter weight and therefore any mirror shifts may occur faster than if the mirror were further away, larger, and therefore heavier. The tilting mirror may be a galvo mirror, a 1D or 2D VCM 200, or a piezo of Micro Electro Mechanical Systems (MEMS) mirror. Alternatively or additionally, the means by which the optic axis is rotated may be by a tunable or insertable wedge element contained within imaging unit 106.

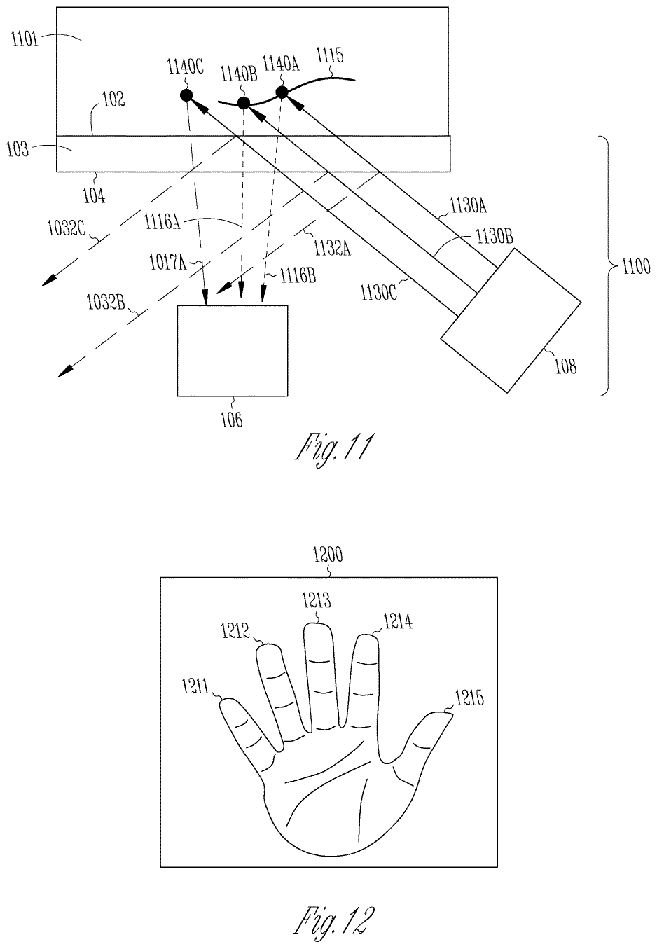

FIG. 9 is an illustration of a subset 900 of the components of a document scanning device 100 and how it can be used to scan a biometric presentation. Specifically, a document scanning device can be used to scan friction ridge detail (e.g., a fingerprint ridge detail), as well as vein detail, as well as hand geometry for the purposes of biometric verification and identification. Friction ridge detail 910 is comprised of skin ridges 911 and skin valleys 912. Although friction ridge detail 910 is illustrated in FIG. 9 as part of a finger 905, the friction ridge detail may be one or more fingers, a thumb, a palm or any other portion of the human skin. A vein pattern 915 may be scanned at substantially the same time as the fingerprint ridge detail 910 or alternatively for the purposes of performing a biometric identification.

For the scanning of friction ridge detail, the preferred illumination spectrum is green or blue light. Red or NIR light has increased transmission into the skin, reradiates and scatters back out, resulting in an image with low contrast between the skin topology's ridges and valleys. It is further preferred that the angle of incidence of the light striking the contact surface 102 is at or less than 45 degrees as measured in air with respect to surface normal of the contact surface 102.

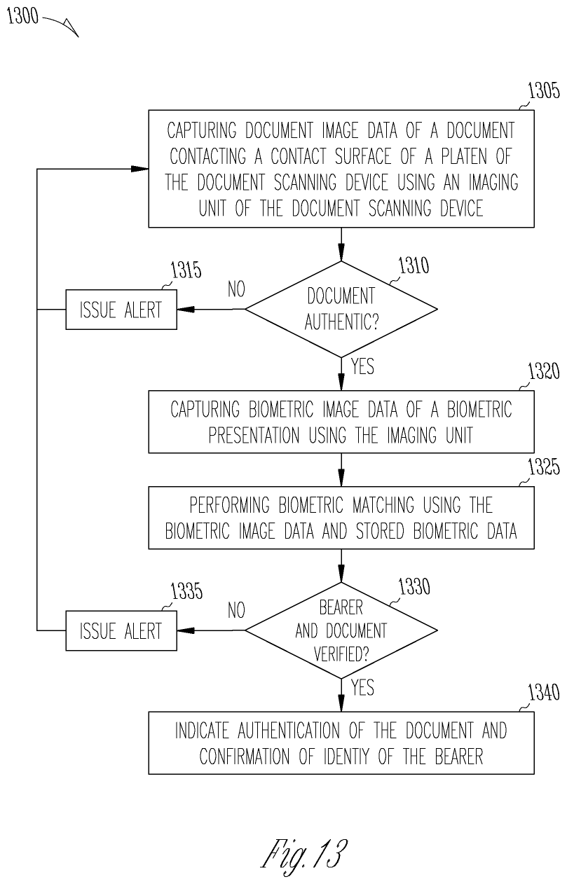

FIG. 10 is an exaggerated view 1000 of the platen 103 area of the document scanning device 100 of FIG. 9, illustrating how friction ridge topology 1010 is preferably illuminated and imaged when placed on document scanning device 100. Illumination unit 108 projects light rays 1030A-C at contact surface 102 of platen 103 of the document scanning device. The illumination unit 108 is preferably positioned such that the specular reflection of light rays 1030A-C off of contact surface 102 and bottom surface 104 of the platen (e.g., rays 1040 and 1041) are not imaged by imaging unit 106, or if the rays are imaged, these specular reflections appear outside of the imaging area of interest for the biometric presentation. As illustrated, specular reflection light ray 1040 from contact surface 102 misses imaging unit 106 and specular reflection light ray 1041 reflecting off bottom surface 104 enters the imaging unit 106 but it is outside of the angular FOV of the imaging unit 106 and does not get imaged. Note further that although platen 103 is drawn as a planar parallel structure, it may be constructed as a wedge and may additionally or alternatively contain anti-reflection (AR) coatings on one or more of contact surface 102 or bottom surface 104 to further minimize the potential of specular reflections from contact surface 102 or bottom surface 104 creating issues.

A friction ridge topology 1010 is shown placed onto contact surface 102 and the topology comprises a plurality of ridges 1011A, 1011B and valleys 1012. Imaging unit 106 does not image any specular reflections off ridges 1011A, 1011B for the same reason that it does not image any reflections from platen contact surface 102. The only light that imaging unit 106 should preferentially detect from ridges 1011A, 1011B is that light that penetrates into the skin of the ridges and then scatters at an angle that is within the FOV of imaging unit 106. To minimize the detection of these scattered rays (not shown), illumination unit 108 may emit polarized light and the imaging unit 106 may have the means by which to sample reflected light that is of the same polarization as the source light, thereby maximizing the detection of specular light and minimizing the detection of scattered light, as the scattered light will be depolarized.

Light rays 1030A-C interact with friction ridge topology 1010 and produce specular reflections 1031A-C at valleys 1012. Some of these specular reflections, for example rays 1031A and 1031B, miss imaging unit 106, while others, for example light ray 1031C, are imaged. The relatively high amount of light in specular reflection light ray 1031C relative to the scattered light from other rays emanating from illumination unit 108 and interacting with valleys 1012 and ridges 1011A, 1011B results in a high contrast image where ridge-valley transitions of friction ridge topology 1010 are bright and other areas of friction ridge topology 1010 are dark.

Because the imaging of specular reflection rays such as ray 1031C is dependent upon the orientation of the ridge-valley transition relative to the orientation of light from illumination unit 108, it is preferred that multiple illumination sources are positioned about platen 103 in order to illuminate friction ridge topology 1010 from multiple peristrophic angles directions. For each direction of light, one or more images may be captured or multiple illumination angles may be captured with a single image, particularly if the different illumination directions are at different wavelengths and a color discrimination image sensor is used. The multiple images may then be fused together into a composite image, taking the best contrast areas of each image to achieve the single composite image that represents the friction ridge topology biometric presentation. The composite image may be enhanced to mimic a legacy print, such as that taken from a total internal reflection prism-based optical scanner or an ink on card, through such techniques as flat-field correction, geometrical correction, contrast limited adaptive histogram equalization (CLAHE), non-local means denoising, or other image processing techniques designed to improve the fidelity of the captured images. Alternatively, or in addition, some or all of the image processing algorithms to be executed on the image data collected by imaging unit 106 may be executed by host computer 141 that the document scanning device 100 may be connected to in a wired or a wireless communication means. From the final processed image, biometric matching may be performed either on a common minutiae basis (as with fingerprinting) or with a more complicated ridge flow matching algorithm.

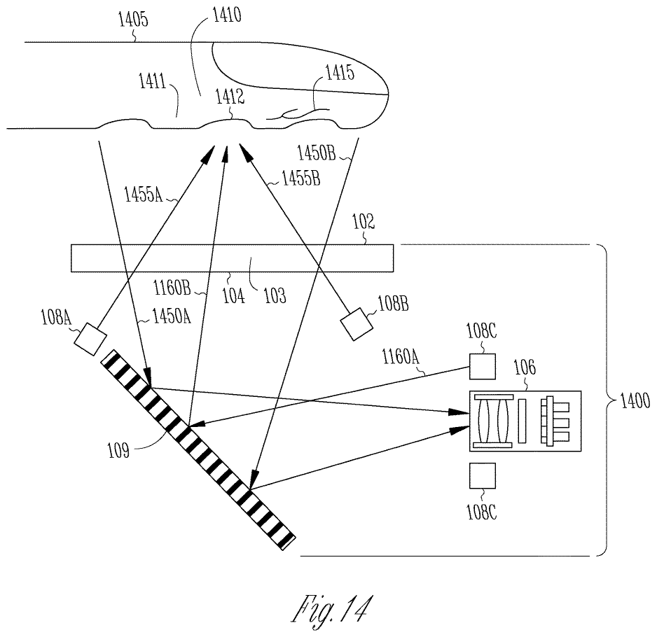

FIG. 11 illustrates a portion of human skin 1101 and a portion of an example of a document scanning device 1100. The portion of human skin 1101 has at least one vein 1115 in contact with contact surface 102 of document scanning device 1100. One or more illumination units 108 are contained within a housing of the document scanning device 1100 and the illumination units 108 emit light rays 1130A-C towards skin 1101. Because veins carry deoxygenated blood back to the heart and because light must transmit through the epidermis and other skin layers to reach the veins, it is preferred to select light wavelengths that transmit through skin and are absorbed by the vein. Infrared light (IR) satisfies this requirement, in particular wavelengths above 800 nm. Because skin is an inhomogeneous material with numerous scattering sites, light ray 1130C will be scattered as it propagates in skin 1101 (e.g., at location 1140C), where some of the scattered rays (e.g., ray 1117A) will enter imaging unit 106 and be imaged. Light rays 1130A and 1130B, entering skin 1101, will also scatter at various positions within skin 1101. Where light rays 1130A, 1130B interact with vein 1115 at sites 1140A, 1140B, respectively, there will also be scatter 1116A, 1116B, respectively, that can be imaged by imaging unit 106, but to a much lesser extent, due to absorption of the NIR light at the vein, resulting in an image where the veins 115 appear dark compared to the surrounding skin 1101.

As with the positioning of illumination unit 108 when imaging friction ridge topology 1010 as in FIG. 10, illumination unit 108 is positioned such that specular reflection of light emitted by illumination unit 108 when encountering the platen top contact surface 102 or bottom surface 104 misses imaging unit 106 or is outside of the full FOV of the imaging unit 106. By way of example, specular reflection light rays 1132B and 1132C reflecting off of bottom surface 104 and contact surface 102, respectively, miss the imaging unit 106. As a further example, specular reflection light rays 1132A, may enter the imaging unit 106 but is preferably either outside of the angular FOV of the imaging unit 106 or is outside of the imaging area of interest and thereby does not interfere with the fidelity of imaging vein 1115.

As mentioned previously in the description of FIG. 4, to further minimize specular reflections off of contact surface 102 and bottom surface 104, these surfaces may have AR coatings, Also, platen 103 may not be a plane parallel material, but may have a wedge shape. To minimize effects of specular reflections, light emanating from illumination unit 108 (e.g., rays 1130A-C) may be polarized with imaging unit 106 having a means of blocking the polarization direction as with a linear polarizer such that scattered light is preferentially imaged. If the polarization analyzer of imaging unit 106 interferes with its operation as a document scanner, the polarization analyzer may be retractable, such as by using day/night optical filter switches. The optical filter switches may operate with a solenoid such that reversing the applied voltage switches which filter (a visible pass only or a NIR pass only) is placed in front of the day/night camera of imaging unit 106 and the same can be done with a polarizer.

Because veins are beneath the skin surface and away from contact surface 102 that a document is placed upon, and because the imaging optics within imaging unit 106 may have different focal lengths at the NIR wavelengths preferred to image veins versus the focal length for the visible wavelengths required to image a document, having variable focus optics within imaging unit 106 may be preferred. Variable focus optics may be provided through such means as liquid lens, VCM 200, and deformable polymers as previously discussed herein regarding the imaging unit 106.

FIG. 12 illustrates an image 1200 captured by imaging unit 106 of the document scanning device 100 for the case of the contact biometric presentation being a hand 1210. Particularly with fingers 1211-1215 being spread, landmark positions of where fingers begin and end and their relative relations may be calculated by processors 130 and 230 or by processors within a host computer 141 and this information be used to match the biometric hand geometry of an individual. Illumination unit 108 in this case is preferentially illuminating the hand at a more direct or normal incidence angle, so it may be preferential to position this illumination unit designed for illumination of a hand presentation to be in line with imaging unit 106. The spectrum emitted by illumination unit 108 is not critical as the light may only illuminate the hand in order to determine the hands outline so any wavelength that has suitable contrast relative to the ambient light above the hand would be suitable. By way of example a blue wavelength may be preferred as ambient light typically has low blue or violet light levels.

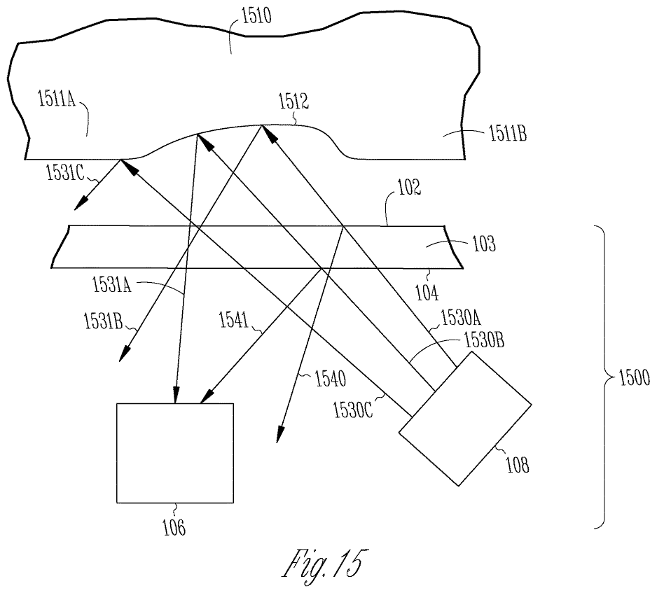

FIG. 13 is a flow diagram of an example of a method 1300 of operating a document scanning device to authenticate documents and authenticate the bearer of the documents. In operation 1305, document image data of a document is captured. The document image data relates to an image of the document contacting a contact surface of the platen of the document scanning device 100 and is obtained using an imaging unit of the document scanning device.

In operation 1310, whether the document is authentic is determined using the document image data and one or more verification algorithms performed by the controller of the document scanning device 100. In operation 1315, if the document is not authentic the document scanning device 100 issues an alert. The alert may be an alert message displayed on a user interface of the document scanning device, or the controller may send the alert from the control PCB 110 to the host computer 141 via the communication port 111.

In operation 1320, biometric image data of the bearer of the document is captured. The biometric image data relates to an image of a biometric presentation and is obtained using the imaging unit. According to some examples, the biometric presentation contacts the contact surface of the platen. The biometric presentation can include at least one finger of the bearer or an entire hand of the bearer contacting the platen.

In operation 1325, biometric matching is performed using the document scanning device 100. The biometric matching is performed using biometric image data of the biometric presentation and stored biometric data. A biometric matching algorithm may be performed by the controller of the document scanning device, and the stored biometric data may be stored in memory 131, 132, 231, or 232. In variations, a biometric matching algorithm may be performed by the host computer 141. The biometric image data is sent from the control PCB 110 to the host computer 141 and the stored biometric data is stored in memory of the host computer 141. In operation 1330, it is verified whether the biometric image data of the biometric presentation is associated with the document. If the bearer is not verified, an alert is issued in operation 1335. In operation 1340, if both authenticity of the document and identity of the bearer of the document are verified, an indication of the authentication of the document and confirmation that the bearer is the same person identified in the document is provided by the document scanning device.

The techniques of contact biometric scanning described allow the same document scanning device 100 to not only authenticate a document but to also authenticate the bearer of that document. The document scanning device 100 may also be used to authenticate the identity of the operator of the apparatus, such as part of a login process for a secure border crossing station.

According to some examples, at operation 1320, the document scanning device 100 performs a non-contact biometric scan of a biometric presentation in addition to authenticating a document. The biometric presentation does not contact the platen 103 and the presentation may be above the contact surface 102 of the platen 103. As in the contacting biometric presentation and scan, this allows the document scanning device 100 to match the identity specified on the document to the identity of the bearer of the document.

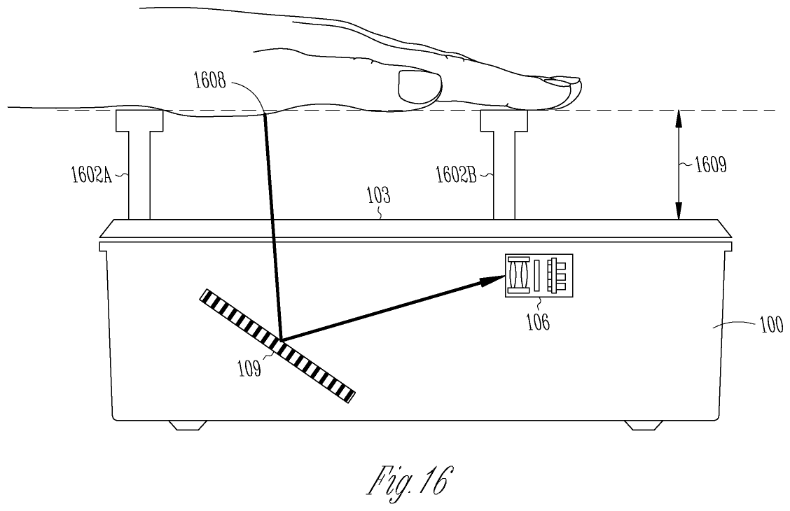

FIG. 14 is an illustration of a subset 1400 of the components of a document scanning device 100 and how it can be used to scan a non-contact biometric presentation that does not contact the surface of the platen 103. The document scanning device 100 can be used to scan friction ridge detail (including skin creases), as well as vein detail, as well as hand geometry for the purposes of biometric verification and identification. Friction ridge detail 1410 is comprised of skin ridges 1411 and skin valleys 1412. Although friction ridge detail 1410 is illustrated in FIG. 14 as part of a finger 1405, the friction ridge detail 1410 may be that of one or more fingers, a thumb, a palm or any other portion of the human skin. A vein pattern 1415 may be scanned at substantially the same time as the fingerprint ridge detail 1410 or alternatively for the purposes of performing a biometric identification. As in the contacting biometric presentation example, the preferred illumination spectrum is green or blue light for the non-contact scanning of friction ridge detail. Red or NIR light has increased transmission into the skin, reradiates and scatters back out, resulting in an image with low contrast between the skin topology's ridges and valleys.

FIG. 15 is an exaggerated view 1500 of the platen 103 area of a document scanning device 100 of FIG. 14, illustrating how friction ridge topology 1510 is preferably illuminated and imaged in a non-contact biometric presentation. Illumination unit 108 projects light rays 1530A-C at contact surface 102 of platen 103 of the document scanning device 100. Illumination unit 108 is preferably positioned such that the specular reflection of rays 1530A-C off of platen contact surface 102 and bottom surface 104 (e.g., rays 1540 and 1541) are not imaged by imaging unit 106, or if the rays are imaged, these specular reflections appear outside of the imaging area of interest for the biometric presentation. As illustrated, specular reflection light ray 1540 off of contact surface 102 misses imaging unit 106 and specular reflection light ray 1541 reflecting off of bottom surface 104 enters the imaging unit 106 but is preferably outside of the angular FOV of the imaging unit 106 and does not get imaged. Note further that although platen 103 is drawn as a planar parallel structure, it may be constructed as a wedge and may additionally or alternatively contain anti-reflection (AR) coatings on one or more of contact surface 102 and bottom surface 104 to further minimize the potential of specular reflections from contact surface 102 or bottom surface 104 creating issues.

A friction ridge topology 1510 is shown placed above contact surface 3102 and the topology comprises a plurality of ridges 1511A, 1511B and valleys 1512. Imaging unit 106 does not image any specular reflections off of ridges 1511A, 1511B for the same reason that it does not image any off of contact surface 102. The ridges are preferentially reasonably in a plane perpendicular to the optic axis and therefore the ridges are preferentially running roughly colinear to contact surface 102. Although a friction ridge detail scanner may be designed to scan fingers or other skin presentations that are purposely tilted relative to surface 102, this is not the most desirable position. It is easier for a human subject to align their hand or fingers to be parallel to a surface rather than align their hand or fingers to be at a set angle. Further, having large tilts of the surface normal of the overall presented friction ridge topology 1510 relative to the optic axis of imaging unit 106 results in a defocus. Although the image processing can be made to compensate for the defocus, it is not desirable as these large tilts should be minimized. Therefore, the imaging unit 106 preferentially detects from ridges 1511A, 1511B light that penetrates into the skin of the ridges and then scatters at an angle that is within the FOV of imaging unit 106. To minimize the detection of these scattered rays (not shown in FIG. 15), illumination unit 108 may emit polarized light and imaging unit 106 may have the means by which to sample reflected light that is of the same polarization as the source light, thereby maximizing the detection of specular light and minimizing the detection of scattered light, as the scattered light will be depolarized.

Light rays 1530A-C interact with friction ridge topology 1510 and produce specular reflection light rays 1531A-C at valleys 1512. Some of these specular reflections, for example, rays 1531B and 1531C, miss imaging unit 106, while others (e.g., light ray 1531A) are imaged. The relatively high amount of light in specular reflection light ray 1531C relative to the scattered light from other rays emanating from illumination unit 108 and interacting with valleys 1512 and ridges 1511A, 1511B results in a high contrast image where ridge-valley transitions of friction ridge topology 1510 are bright and other areas of skin topology 1510 are dark. Because the imaging of specular reflection rays such as ray 1531A is dependent upon the orientation of the ridge-valley transition relative to the orientation of light from illumination unit 108, it is preferred that multiple illumination sources are positioned about platen 103 in order to illuminate friction ridge topology 1510 from multiple peristrophic angles directions. For each direction of light, one or more images may be captured, or multiple illumination angles may be captured with a single image, particularly if the different illumination directions are at different wavelengths and a color discrimination image sensor is used. The multiple images may then be fused together in a composite image by the imaging unit 106 or the controller, taking the best contrast areas of each image to achieve the single composite image that represents the friction ridge topology biometric presentation. The composite image may be enhanced to mimic a legacy print, such as that taken from a total internal reflection prism-based optical scanner or an ink on card, through such techniques as flat-field correction, geometrical correction, CLAHE, non-local means denoising, or other image processing techniques to improve fidelity of a biometric image. From the final processed image, biometric matching may be performed either on a common minutiae basis or with a more complicated ridge flow matching algorithm.

When scanning friction ridge topology 1510 (e.g., fingerprints and palm prints), it is desirable to know the electronic resolution of the images that are taken. When the friction ridge to be scanned is placed in contact with the contact surface 102 of the platen of the document scanning device 100, the electronic resolution is easily determined. At the factory, resolution targets may be placed across the platen contact surface 102, images of which can be taken. Upon analysis, the calculated resolution may be stored in non-volatile memory 132 of the document scanning device 100. If the distortion of the imaging unit 106 is low enough, the electronic resolution stored in the memory may be a single value for the entire surface. If there is high enough variation of magnification (e.g., distortion) across the image area of the platen contact surface 102, then additional parameters may be stored. These parameters may serve as coefficients for an equation that maps the electronic resolution across the contact surface 102 or may serve as a lookup table for calculating through the electronic resolution at any given coordinate location of the contact surface. A variety of down sampling algorithms (such as bilinear or bicubic interpolation) can be executed using embedded code and processors within the document scanner or via code and processing present on the host computer 141. Through the down sampling algorithm, one may down sample the collected image to an electronic resolution that is a standard (e.g., 500, 508, or 1000 pixels per inch (ppi)) as well as to remove any excess distortion in the optical image.

For friction ridge detail of a biometric presentation that is placed above the document scanner's contact surface (i.e., a non-contact biometric presentation), the electronic resolution may not be factory calibrated and stored in the non-volatile memory 132 of the device, as the distance from the contact surface 102 to the friction ridge detail is not known a priori. Thus, a distance measuring means is desired to measure or determine the distance the friction ridge detail is above the platen 103 where the distance measuring means has sufficient accuracy to ensure that the calculated electronic resolution meets the desired or required accuracy (e.g., 0.7%). The distance above the contact surface 102 may be determined using a distance measuring means that measures the distance above the contract surface 102 using one or more of stereo imaging, triangulation, ultrasonic, and/or time-of-flight (ToF). If it is expected that there is no guidance (mechanical or otherwise) of the fingers, palm, or hand containing the friction ridge detail as they are presented to the document scanning device 100 and the deviation of the location of the friction ridge detail presented to the palm scanner is larger than the depth of focus of the imaging unit 106 (e.g., the average surface normal of the fingers or palm may be tilted relative to the optical axis of the surface module), then it is preferred that the distance measuring means can determine the distance of the friction ridge detail above the contact surface 102 at different spatial locations.

By way of example, a distance measuring means using a ToF camera is preferred over a distance measuring means using a simple ultrasonic distance sensor, as the former is capable of generating an image that maps the distance of various objects or features of a presented object as opposed to the latter that generally reports the average distance of the object. Having a mapping of the distance of an object is advantageous to know how the electronic resolution of the image of an object may change as well as providing direction to an autofocus mechanism that may be part of the imaging unit 106 in order to achieve best focus via the capture and subsequent local tiling of a collection of focus-stacked images. Additionally, or alternately, well-focused images with known electronic resolutions may be captured of non-contact biometric presentations using a calibrated autofocus mechanism. For example, if a liquid lens, VCM, or similar autofocus means within the imaging unit 106 has a well-calibrated position feedback means, then, based upon a reading that may include a voltage or current, the position of a lens and therefore the object focus plane (e.g., the distance of the object) may be recorded for each image taken. Therefore, when imaging the biometric presentation with one image or a focus stacked set of images which are later fused to create one composite image that meets focus requirements, then the distance, and therefore the electronic resolution of the biometric image may be determined for each point across the biometric presentation. Knowing the electronic resolution of an image, particularly if the resolution changes as a function of spatial location, can be important in order to down sample the image to a required specification and precision, such as 500 ppi±1% that many extract and matching fingerprint algorithms require, and further may be preferred or required by certain government or law enforcement agencies, such as the U.S. Federal Bureau of Investigation (FBI).

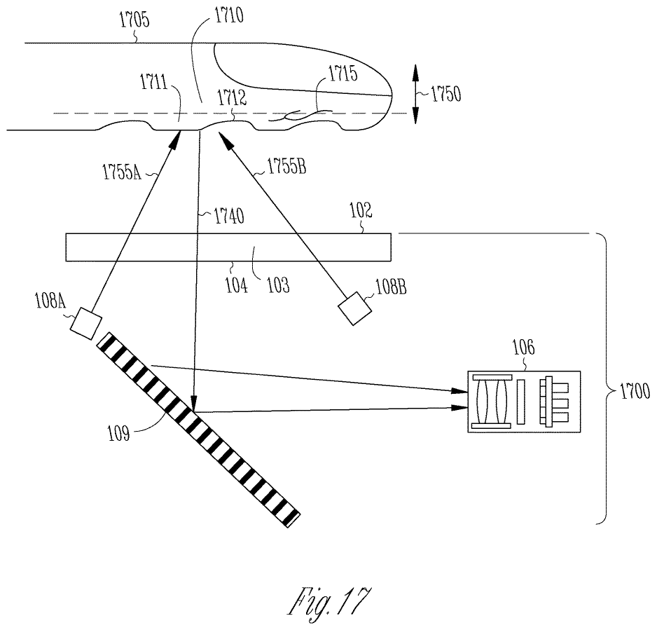

FIG. 16 is an illustration showing another example of a non-contact biometric presentation, such as a palm 1608 of a hand, above a platen 103 of a document scanning device 100 and not contacting the platen 103. As shown, to minimize the need for an autofocus mechanism, the document scanning device 100 may have one or more mechanical structures on or above the platen 103 which can be used to position one or more of the hand, palm, or fingers of the document bearer or operator at a specified distance over the platen 103. The form of the structures is designed to limit the amount of ambient light that reaches the imaging unit 106 of the document scanning device 100. Such structures can be designed to serve not only as light shields but also for the placement of friction ridge topology for being scanned. By way of example, the hand (or fingers of the hand) may be inserted in a cavity (not shown) created by the mechanical structure. Further, the hand may be expected to have the back of the hand and/or the back of the fingers pressed against an inside top cover of the mechanical structure within that cavity such that the friction ridge topology is the furthest it can be from the document scanner's contact surface 102. In some embodiments, sensors on the inside top cover of the mechanical structure within the cavity can indicate whether the back of the hand/fingers was so pressed, prompting the scanner to switch from document scanning mode to biometric presentation capture mode.

If the friction ridge topology is in a relatively well-defined plane 1606, focus stacking of images may not be required and a single image may be all that is required to achieve a sufficiently focused image of the desired area of the friction ridge being presented. Further, an autofocus algorithm may not be required in that when the document scanning device 100 is set in a print/fingerprint capture mode, it automatically switches the focus of the imaging unit 106 from the contact surface 102 where the document is expected to be placed to that plane 1606 above the surface of the platen 103 where the friction ridge biometric presentation is expected. Other mechanical structures or mechanisms may be provided for fixing the plane 1606 of the friction ridge biometric presentation.

In the example of FIG. 16, the mechanical structures include two rods 1602A, 1602B that may be supported above the contact surface of the platen 103 where the bearer of the document or the operator is expected to place their wrist against one rod 1602A and their fingers against the second rod 1602B, thereby supporting the palm 1608 to be scanned in a plane 1606 a fixed distance 1609 above the contact surface of the platen 103. In some embodiments, only one rod may be used to support the hand, although, use of two (or more) rods 1602A, 1602B is recommended to minimize the angling of the hand position upwards or downwards with respect to platen 103, which can result in a significantly different distance between the fingers and the platen and the palm and the platen 103. In some embodiments, sensors on the tops of the rods 1602A, 1602B can indicate whether the hand is being pressed against them, thus signaling a print should be scanned of a hand above the platen 103 and prompting the document scanning device 100 to switch from document scanning mode to print/fingerprint capture mode. By implementing such a mechanical structure and method of placing the hand/fingers, the distance 1609 the friction ridge topology will be from the document scanning device 100 will be relatively fixed, which aids in focus control and may also aid in illumination of the friction ridge topology. It will be appreciated that the same techniques could be used to support and stabilize other body parts (e.g., a finger or a face) to be scanned in the non-contact presentation.

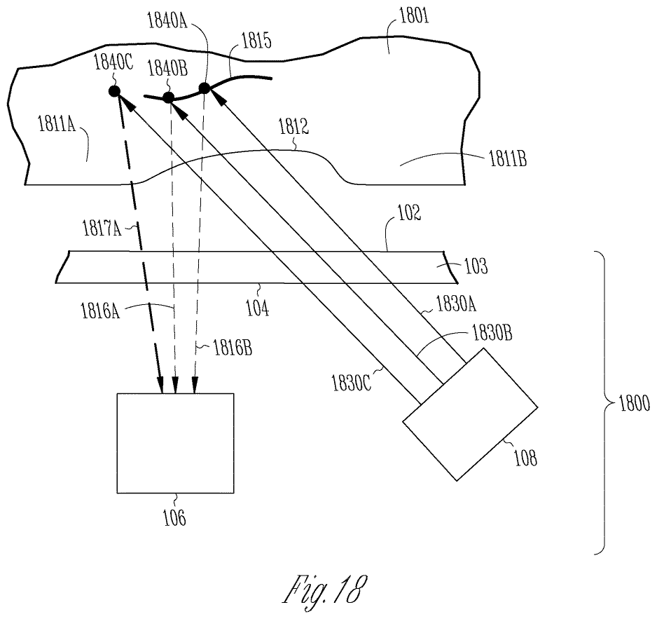

FIG. 17 is an illustration showing another example of a non-contact biometric presentation of a finger 1705 and a portion 1700 of a document scanning device 100. In some examples, the document scanning device 100 may not require an autofocus system, support structure(s), and/or means by which the object focal plane of imaging unit 106 can be changed. For example, as shown in FIG. 17, the biometric presentation (e.g., of the finger 1705) is expected to move along or close to along the optic axis of imaging unit 106. In this manner the biometric presentation can move from a plane that is out of focus to one that is in focus whilst the imaging unit 106, that is designed for at least capturing the non-contact biometric presentation, captures images and analyzes them for quality. In a method implemented for this embodiment, the biometric presentation may start from a position that is relatively close to the document scanning device 100 and out of focus for imaging unit 106 and move away from the document scanning device 100, or it may move from a position that is far from the document scanning device 100 and out of focus and move closer to the document scanning device 100. No physical support structures (e.g., rods 1602A, 1602B from FIG. 16) are required, and the user moves his or her hand through the space above the scanner.

FIG. 17 illustrates a portion 1700 of the document scanning device 100 containing a platen 103 with contact surface 102 and an imaging unit 106 designed to capture one or more images of a non-contact biometric presentation. The example of FIG. 17 shows a non-contact biometric presentation to the device of a finger 1705 containing friction ridge topology 1710, comprising ridges 1711 and valleys 1712, and veins 1715. The biometric presentation is not in contact with contact surface 102 of the platen 103 but is within the field-of-view (FOV) of imaging unit 106. Other examples of the non-contact biometric presentation can include a plurality of fingers, a hand, a palm, face, iris, or any other biometric presentation that is placed within the FOV of the imaging unit 106 of the document scanning device 100. This biometric presentation may be moved along direction 1750 which is relatively in-line with the optic axis of 1740 of imaging unit 106. In this manner, as the biometric presentation moves, the document scanning device 100 may collect a stack of images. In some embodiments, the scanner may indicate (e.g., by visual and/or audio cues) instructions on how to move the biometric presentation (e.g. finger 1705) so that the biometric presentation is properly moved and may do so by evaluating the images it has taken up to that point. A composite image may be formed by analyzing the portions of the image for each image within the image stack that is in focus and segmenting these portions of images. Any resulting tiling effects can be mitigated by blending images within the stack. It is preferred that the depth of focus of imaging unit 106 is small enough that any magnification change across the composite image is within an acceptable error specification for the device (e.g., within ±0.7%).

FIG. 18 illustrates another example of a portion of human skin 1801 and a portion of a document scanning device 1800. The portion of human skin 1801 is positioned above contact surface 102 of the platen 103 of the portion of the document scanning device 1800 and has at least one vein 1815. The document scanning device contains one or more illumination units 108 that emits light rays 1830A-C towards human skin 1801 portion. Because veins carry deoxygenated blood back to the heart and because light must transmit through the epidermis and other skin layers to reach the veins, it is preferred to select light wavelengths for the illumination units 108 that transmit through skin and are absorbed by the vein. Infrared light (IR) satisfies this requirement, in particular wavelengths above 800 nm. Because skin is an inhomogeneous material with numerous scattering sites, light ray 1830C will be scattered as it propagates in skin 1801 (e.g., example at location 1840C), where some of the scattered rays (e.g., example 1817A) will enter imaging unit 106 and be imaged. Light rays 1830A and 1830B will also scatter at various positions when entering skin 1801. Where light rays 1830A, 1830B interact with vein 1815 at sites 1840A, 1840B, respectively, there will also be scatter 1816A, 1816B, respectively, that can be imaged by imaging unit 106, but to a much lesser extent than light ray 1830C due to absorption of the NIR light at the vein. The result is an image where the veins 1815 appear dark compared to the surrounding skin 1801.

As with the positioning of illumination unit 108 in FIG. 15 when imaging friction ridge topology 1510, illumination unit 108 in FIG. 18 is positioned such that specular reflection of light emitted by the illumination unit 108 when encountering top contact surface 102 of the platen 103 or bottom surface 104 of the platen 103 misses imaging unit 106 or is outside of the FOV of the imaging unit 106. As mentioned in the description regarding FIG. 15, to further minimize specular reflections off of contact surface 102 and bottom surface 104, these surfaces may have AR coatings as well as platen 103 may not be a plane parallel material, but one with a wedge shape.

Because the imaging of vein 1815 relies upon scattered light as opposed to specular light as in the case of imaging the friction ridge topology 1510 shown in FIG. 15, it is desirable to minimize specular light emanating off of valleys 1812 or if present ridges 1811A, 1811B as well. To minimize these specular reflections, light emanating from illumination unit 108, for example, rays 1830A-C, may be polarized with imaging unit 106 having a means to block the polarization direction (e.g., a linear polarizer) such that scattered light is preferentially imaged. If the polarization analyzer of imaging unit 106 interferes with its operation as a document scanner, the polarization analyzer may be retractable, such as by using day/night optical filter switches. Optical filter switches may be operated with a solenoid such that reversing the applied voltage switches which filter (a visible pass only or a NIR pass only) is placed in front of the day/night camera and the same can be done with a polarizer. Alternatively, imaging unit 106 may be capable of detecting different polarization directions, for example through the use of image sensors employing Sony's Polarsens™ technology or Metalenz's PolarID™ technology. With Sony's Polarsens™ technology wire grid polarizers of different orientations are placed upon different pixels so that the image sensor is capable of outputting four different images of a scene with each image indicating a different orientation of polarization (0°, 45°, 90°, and 135°) With the Metalenz PolarID™ technology, a metasurface is used to also split the imaged scene into different polarization components, but it has the advantage that it is lossless compared to the wire grid polarizers of Sony's technology. Metalenz's PolarID™ technology is then able to output four images of a scene, one for each of the Stokes vector parameters S₀ through S₃.

Because veins 1815 are beneath the skin surface and away from contact surface 102 that a document is placed upon, and because the imaging optics within imaging unit 106 may have different focal lengths at the NIR wavelengths preferred to image veins versus the focal length for the visible wavelengths required to image a document, having variable focus optics within the imaging unit 106 may be preferred. The variable focus optics may be provided through such means as liquid lens, VCM, and deformable polymers as previously discussed in relation to the imaging unit 106 in FIGS. 1 and 2.

For the case of the non-contact biometric presentation being a hand 1210 as in FIG. 12, the hand 1210 is positioned above the contact surface 102 rather than on the contact surface 102. Particularly with fingers 1211-1215 being spread, landmark positions of where fingers begin and end and their relative relations may be calculated by processors 130 and 230 of the document scanning device 100 or by processors within the host computer 141 and this information be used to match the biometric hand geometry of an individual. Illumination unit 108 in this case is preferentially illuminating the hand at a more direct or normal incidence angle, so it may be preferential to position this illumination unit designed for illumination of a hand presentation to be in line with imaging unit 106. The spectrum emitted by illumination unit 108 is not critical as the light may need only to illuminate the hand in order to determine the outline of the hand 1210 so any wavelength that has suitable contrast relative to the ambient light above the hand would be suitable. By way of example, a blue wavelength may be preferred as ambient light typically has low blue or violet light levels.

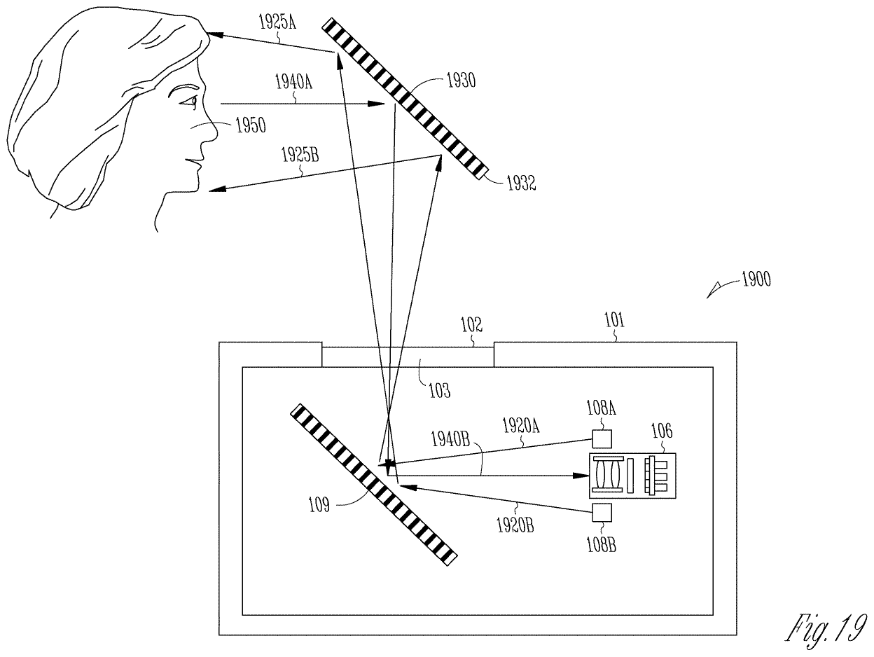

FIG. 19 illustrates another example of a portion of a document scanning device 1900. A mirror 1930 is added to document scanning device 1900, enabling a face or iris presentation 1950 to be imaged. Mirror 1930 is an ergonomic addition to the document scanning device 1900 as in theory it is possible to bend over platen 103 to present a face or iris above the contact surface 102, but it is not nearly as convenient or user-friendly an action to perform compared to placing a finger, hand, or palm above contact surface 102. Since face or iris presentation 1950 will be further away from imaging unit 106, it is desirable that illumination units 108A, 108B that illuminate the face or iris presentation be more colinear to imaging unit 106. For the capture of an iris, it is recommended that the illumination be between 5 and 10 degrees off of the imaging axis to ensure that the specular reflection of the illumination stays within the images'pupil area of the eyes and that it does not create a red-eye effect (where the pupil, instead of looking black looks partially red or red). For packaging reasons this requirement may not always be possible to maintain. An alternative is to have the illumination less than 5 degrees and ensure that the pupil always has red eye and that in image processing correct the red eye and return the pupil to a dark or black shading as required by such standards as ISO/IEC FDIS 29794-6:2014. In cases where the angle is above 10 degrees and the specular reflection of the illumination unit drifts into the iris portion of the eye, it is convenient to have two illumination units, for example illumination units 108A and 108B that can separately illuminate the presented iris. For one illumination unit, the specular reflection in the image occludes a portion of the iris that the other does not occlude and vice versa and in such manner the entire iris imagery may be captured. Illumination wavelength of the iris should desirably have >90% of its spectrum in the 700-900 nm range with >35% being in the 800-900 nm range according to ISO/IEC FDIS 29794-6:2014. Consequently, illumination units 108A, 108B are preferably designed to conform to this spectral requirement (such as with the use of 760 nm and 850 nm LEDs). Further mirror 1930 may have a reflection spectrum of mirror surface 1932 that is tuned to have high reflectivity for this internal NIR illumination spectrum and low reflectivity for visible wavelengths, thereby assisting to limit the effects of ambient light. The reflection spectrum may be achieved with a multi-layer thin film coating applied to mirror surface 1932.

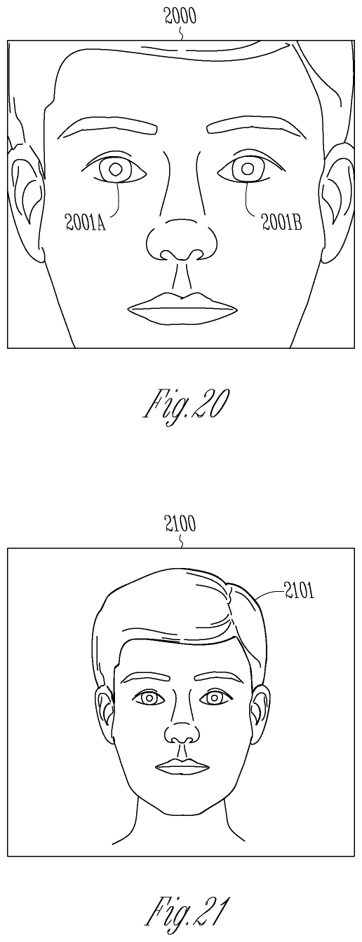

FIG. 20 is an example image 2000 captured by document scanning device 1900 from a non-contact biometric presentation. The eyes 2001A and 2001B of a human subject are visible in the image 2000. This image is preferably captured by NIR light as previously discussed and although two eyes are present, image 2000 may also contain a single eye in the image. Two eyes are preferable to one because biometric matching performed on both eyes increases the match accuracy. Further, by determining the coordinates of the center of each iris or pupil one may determine the tilt angle of the head which may be corrected prior to segmenting the iris and generating a template. With this iris template a match operation may be performed between the iris template and those stored within document scanning device 1900 or those stored in a host computer 141 which the iris presentation is expected to match.

Returning to FIG. 19, illumination units 108A, 108B may emit visible or NIR light for the capture of the face presentation 1950. However, for purposes of also integrating an iris scanner, or for having a more pleasant user experience, rather than illuminating a face presentation with a visible spectrum of light, using an NIR spectrum may be preferred. If the face presentation is captured in NIR, then as explained earlier in relation to the capture of iris biometric presentations, the surface of mirror 1930 may have a coating which maximizes the NIR reflection while minimizing visible reflections and thereby aid in the handling of ambient light.

FIG. 21 illustrates an example image 2100 of the face 2101 of a human subject captured by a non-contact biometric presentation to the document scanning device 1900. This image 2100 should comply with common best practices for face biometric capture and with the capture of the face imagery, the extraction of facial landmarks (e.g., relative positions of eyes, nose, and mouth features) or other means may be performed in order to form a biometric match versus face data stored within document scanning device 1900 or on a host computer 141 that is connected physically or wirelessly to document scanning device 1900.

It should be noted that in the various examples presented, the imaging unit 106 for the non-contact biometric presentation capture may be the same or a different one compared to the one used for the capture of document presentations. By way of example, a face or iris may be sufficiently far from the platen 103 that the document is placed on. The resolution needed for capturing the face or iris might be different from the resolution needed to capture the document. The FOV of the imaging unit may be different as well resulting in a need for a different focal length lens than that for document scanning. Further, documents placed on a platen 103 tend to be relatively immobile and mask a major portion of ambient light. For a non-contact biometric presentation, that presentation may be moving slightly and ambient light will be more of a factor. Therefore, it is advantageous if the imaging unit 106 capturing the biometric presentation incorporates a global shutter CMOS sensor. Further it is preferable that one or more illumination units (e.g., 108A, 108B) designed for illumination of the non-contact biometric presentation are pulsed and in synch with the frame capture of the global shutter CMOS sensor. Further, because the non-contact biometric presentation is made above the contact surface 102 of the platen 103, either the imaging unit 106 for the document capture has a means of adjusting focus (as previously discussed) or is a separate from the imaging unit 106 used for biometric capture. This separate imaging unit 106 may also have the means of adjusting focus and may further perform a focus sweep to capture a biometric presentation. With this focus sweep, multiple images are captured at different focus distances, and the in-focus portions of each image may be fused together to achieve a single image that is in focus. Focus sweeping is advantageous when an iris presentation may be performed with the head rotated about the neck so that the two irises are at slightly different distances from the imaging unit 106 of the scanner. Further, the focus sweep is advantageous when a multi-finger or a hand or palm presentation is made wherein that body part presentation is tilted with respect to the optic axis of the imaging unit 106. By way of example, without focus sweep, a captured image of a four fingers skin presentation may result in some of the fingers or portions of some of the fingers being out of focus. A sweep focus solves this problem.

As with contact biometric scanning, the techniques of non-contact biometric scanning described allow the same document scanning device 100 to not only authenticate a document but to also authenticate the bearer of that document. The document scanning device 100 may also be used to authenticate the identity of the operator of the apparatus, such as part of a login process for the operator.

### Additional Disclosure and Examples

[Examples will be added here by attorney when the draft application is approved.]

These non-limiting Examples can be combined in any permutation or combination. The above detailed description includes references to the accompanying drawings, which form a part of the detailed description. The drawings show, by way of illustration, specific embodiments in which the invention can be practiced. These embodiments are also referred to herein as “examples.” All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. In the above Detailed Description, various features may be grouped together to streamline the disclosure. This should not be interpreted as intending that an unclaimed disclosed feature is essential to any claim. Rather, the subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope should be determined with reference to the appended claims, along with the full scope of equivalents to which such claims are entitled.

What is claimed is:

1. A document scanning device, the device comprising:
a platen including a contact surface on which documents to be scanned are placed;
an imaging unit to capture image data of the documents;
a calibration feature;
a memory; and
a controller operatively coupled to the memory and the imaging unit and configured to:
initiate capture of image data of a calibration feature included in the document scanning device by the imaging unit;
measure imaging calibration metrics of the calibration feature using the image data;
compare the measured imaging calibration metrics to stored calibration metrics stored in a memory of the document scanning device; and
initiate a corrective action when one or more of the measured imaging calibration metrics differs from corresponding stored calibration metrics by more than a threshold metric difference.

2. The device of claim 1,
wherein the imaging unit includes an autofocus mechanism; and
wherein the controller is configured to initiate changing a focus setting of the imaging unit as the corrective action.

3. The device of claim 1, including:
an illumination unit; and
wherein the controller is configured to initiate changing current provided to the illumination unit as the corrective action.

4. The device of claim 1,
wherein the imaging unit includes an image sensor; and
wherein the controller is configured to initiate changing an integration time of the image sensor as the corrective action.

5. The device of claim 1,
wherein the controller includes a communication port; and
wherein the controller is configured to, as the corrective action, send a warning indication to a separate device via the communication port that the document scanning device is out of calibration in response to determining the one or more of the measured imaging calibration metrics differs from the corresponding stored calibration metrics by more than the threshold metric difference.

6. The device of claim 1, wherein the calibration feature is positioned within a field of view of the imaging unit but outside a document field of view in which documents are positioned.

7. The device of claim 1, including:
a housing surrounding the platen, wherein the imaging unit, controller, memory, and calibration feature are located within the housing, and the calibration feature is positioned on a bottom surface of the platen opposite the contact surface.

8. The device of claim 1, including:
a housing surrounding the platen and covering a first portion of a top surface of the platen and exposing a second portion of the top surface that includes the contact surface of the platen, wherein the imaging unit, controller, and memory are located within the housing, and the calibration feature is positioned on the first portion of the top surface of the platen.

9. The device of claim 1, including:
a housing surrounding the platen, wherein the imaging unit, controller, memory, and calibration feature are located within the housing, and the calibration feature is positioned on the housing.

10. The device of claim 1, wherein the calibration feature comprises at least one of a slanted rectangle, a bar target, a crosshair, and a circle.

11. The device of claim 1,
wherein the calibration feature comprises a color calibration patch including a pigmentation, and the imaging calibration metrics comprise a color balance metric derived from grayscale values of different color pixels captured from the color calibration patch.

12. The device of claim 1, wherein the calibration feature comprises a diffractive or holographic structure located within the platen.

13. The device of claim 1, wherein the calibration feature comprises a diffractive or holographic structure located within a field of view of the imaging unit and not contacting the platen.

14. The device of claim 1, wherein the imaging calibration metrics comprise a measure of at least one of magnification, distortion, optical resolution, electronic sampling resolution, a modulation transfer function (MTF), and a contrast transfer function (CTF).

15. A method of operating a document scanning device, the method comprising:
capturing image data of a calibration feature included in the document scanning device using an imaging unit of the document scanning device;
measuring imaging calibration metrics of imaging of the calibration feature by the imaging unit;
comparing the measured imaging calibration metrics to stored calibration metrics for the imaging unit stored in the document scanning device; and
initiating a corrective action by a controller of the document scanning device when one or more of the measured imaging calibration metrics differs from corresponding stored calibration metrics by more than a threshold metric difference.

16. The method of claim 15, wherein the initiating the corrective action by the controller includes initiating one or more of a change in focus of the imaging unit, a change in integration time of an image sensor of the imaging unit, and a change in illumination by an illumination unit of the document scanning device in in response to determining the one or more of the measured imaging calibration metrics differs from the corresponding stored calibration metrics by more than the threshold metric difference.

17. The method of claim 15, wherein the initiating the corrective action by the controller includes sending a warning indication to a separate device that the document scanning device is out of calibration in response to determining the one or more of the measured imaging calibration metrics differs from the corresponding stored calibration metrics by more than the threshold metric difference.

18. The method of claim 15, including positioning the calibration feature within a housing of the document scanning device and within a full-field field of view of the imaging unit but outside a document field of view of the imaging unit in which documents are positioned.

19. The method of claim 18, wherein the positioning the calibration feature includes positioning the calibration feature on a platen used to place documents for scanning.

20. A non-transitory computer-readable storage medium storing instructions that, when executed by a processing circuitry of a controller of a document scanning device, cause the processing circuitry to perform operations including:
initiating obtaining image data of a calibration feature included in the document scanning device using an imaging unit of the document scanning device;
measuring imaging calibration metrics of imaging of the calibration feature by the imaging unit using the image data;
comparing the measured imaging calibration metrics to stored calibration metrics for the imaging unit stored in the document scanning device; and
initiating a corrective action when one or more of the measured imaging calibration metrics differs from corresponding stored calibration metrics by more than a threshold metric difference.
